(19) United States
(12) Patent Application Publication
(10) Pub. No.: US 2022/0305883 A1
(43) Pub. Date: Sep. 29, 2022

(54) VEHICULAR AIR-CONDITIONING DEVICE

(71) Applicant: SANDEN AUTOMOTIVE CLIMATE SYSTEMS CORPORATION, Isesaki-shi, Gunma (JP)

(72) Inventors: Tetsuya ISHIZEKI, Isesaki-shi, Gunma (JP); Takefumi TOMIYA, Isesaki-shi, Gunma (JP); Takayuki MATSUMURA, Isesaki-shi, Gunma (JP); Kentaro MORIYA, Isesaki-shi, Gunma (JP)

(73) Assignee: SANDEN AUTOMOTIVE CLIMATE SYSTEMS CORPORATION, Isesaki-shi, Gunma (JP)

(21) Appl. No.: 17/608,825

(22) PCT Filed: May 26, 2020
(86) PCT No.: PCT/JP2020/020661

§ 371 Date: Nov. 4, 2021

(30) Foreign Application Priority Data
May 28, 2019 (JP) 2019-099471

(51) Int. Cl. B60H 1/03; B60H 1/22; F25B 47/02; F25B 49/02; B60H 1/00

(52) U.S. Cl. CPC B60H 1/03; B60H 1/22; F25B 47/02; F25B 49/02; B60H 1/00007

(57) ABSTRACT

There is provided a vehicular air-conditioning device capable of reducing frost formation on an outdoor heat exchanger during vehicle running after disconnection from an external power source and extending a period during which a heating operation can be performed with high efficiency. A battery 55 is capable of being charged from an external power source. A controller 32 causes an outdoor heat exchanger 7 to absorb heat to thereby execute a heating operation to heat a vehicle interior. The controller 32 is capable of executing air preconditioning to preliminarily heat the vehicle interior before boarding. When the air preconditioning is executed in a state in which the battery 55 is connected to the external power source, the controller 32 heats the vehicle interior without using the outdoor heat exchanger 7, and changes a target temperature for heating control in the air preconditioning in the direction of increasing from a reference value of the target temperature.

### CROSS-REFERENCE TO RELATED APPLICATIONS

This application is a U.S. National Stage Patent Application under 37 U.S.C. § 371 of International Patent Application No. PCT/JP2020/020661, filed on Mar. 26, 2020, which claims the benefit of Japanese Patent Application No. JP 2019-099471, filed on May 28, 2019, the disclosures of each of which are incorporated herein by reference in their entirety.

### TECHNICAL FIELD

The present invention relates to a heat pump type vehicular air-conditioning device, and particularly to an air-conditioning device of a vehicle capable of performing air preconditioning for preliminarily heating a vehicle interior before a vehicle is boarded.

### BACKGROUND ART

Due to actualization of environmental problems in recent years, vehicles such as hybrid cars, electric vehicles each of which drives a motor for running by power supplied from a battery mounted on the vehicle have spread. Further, as an air conditioning device which is applicable to such a vehicle, there has been developed a heat pump type vehicular air-conditioning device which includes a refrigerant circuit to which a compressor driven by power supply from a battery, a radiator, a heat absorber, and an outdoor heat exchanger are connected, and which performs letting the refrigerant discharged from the compressor radiate heat in the radiator and letting the refrigerant from which the heat has been radiated in the radiator absorb heat in the outdoor heat exchanger to heat an vehicle interior, and letting the refrigerant discharged from the compressor radiate heat in the outdoor heat exchanger and letting the refrigerant absorb heat in the heat absorber to cool the vehicle interior.

In this case, while the battery is being charged by connecting an external power source such as a quick charger to the battery, the compressor is driven by the power supply from the external power source, and the outdoor heat exchanger has been prevented from frost formation by heating the vehicle interior without circulating the refrigerant in the outdoor heat exchanger (refer to, for example, Patent Document 1).

Further, there has also been developed one in which it is possible to perform air preconditioning to preliminarily air-condition the interior of a vehicle before its boarding. In that case, there has also been developed an air conditioning device which is driven by an external power source (refer to, for example, Patent Document 2).

### CITATION LIST

### Patent Documents

Patent Document 1: Japanese Patent Application Publication No. 2014-226979
Patent Document 2: Japanese Patent Application Publication No. 2001-63347

### SUMMARY OF THE INVENTION

### Problems to be Solved by the Invention

As described above, various proposals have been made for air conditioning inside the vehicle when the battery is being charged from the external power source, but after disconnecting from the external power source and getting on the vehicle and starting its driving, the interior of the vehicle is heated by heat absorption by the outdoor heat exchanger after all. Therefore, it is not possible to solve the problem that a heating capability is lowered due to deterioration in the efficiency of heat exchange with outdoor air due to frost formation.

The present invention has been made to solve such conventional technical problems, and an object thereof is to provide a vehicular air-conditioning device which is capable of reducing frost formation on an outdoor heat exchanger during running after disconnection from an external power source, and extending a period during which a heating operation can be performed with high efficiency.

### Means for Solving the Problems

A vehicular air-conditioning device of the present invention is characterized by including a compressor supplied with power from a battery to compress a refrigerant, a radiator to let the refrigerant radiate heat, thereby heating air to be supplied to a vehicle interior, an outdoor heat exchanger provided outside the vehicle interior, and a control device, and in that the battery is capable of being charged by an external power source, and the control device at least executes a heating operation to heat the vehicle interior by letting the refrigerant discharged from the compressor radiate heat in the radiator, decompressing the refrigerant from which the heat is radiated, and then letting the refrigerant absorb heat in the outdoor heat exchanger. The vehicular air-conditioning device is characterized in that the control device is capable of executing air preconditioning to preliminarily heat the vehicle interior before boarding, and when the air preconditioning is executed in a state in which the battery is connected to the external power source, the control device heats the vehicle interior without using the outdoor heat exchanger, and changes a target temperature for heating control in the air preconditioning in the direction of increasing from a reference value of the target temperature.

The vehicular air-conditioning device of the invention of claim 2 is characterized in that in the above invention, the control device changes the time to start the air preconditioning in the direction of advancing the time as a difference between an outdoor air temperature and the reference value of the target temperature becomes larger.

The vehicular air-conditioning device of the invention of claim 3 is characterized in that in the above invention, the control device changes a rise width of the target temperature in the direction of increasing the rise width as the difference between the outdoor air temperature and the reference value of the target temperature increases.

The vehicular air-conditioning device of the invention of claim 4 is characterized in that in the invention of claim 2 or 3, the outdoor air temperature is an outdoor air temperature at the end of the air preconditioning.

The vehicular air-conditioning device of the invention of claim 5 is characterized in that in the above respective inventions, the control device changes the time to start the air preconditioning in the direction of advancing the time as an outdoor air humidity becomes higher.

The vehicular air-conditioning device of the invention of claim 6 is characterized in that in the above respective inventions, the control device changes the rise width of the target temperature in the direction of increasing the rise width as the outdoor air humidity increases.

The vehicular air-conditioning device of the invention of claim 7 is characterized in that in the invention of claim 5 or 6, the outdoor air humidity is an outdoor air humidity at the end of the air preconditioning.

The vehicular air-conditioning device of the invention of claim 8 is characterized in that in the above respective inventions, the control device calculates the reference value of the target temperature, based on the outdoor air temperature and/or outdoor air humidity at the end of the air preconditioning.

The vehicular air-conditioning device of the invention of claim 9 is characterized in that in the invention of claim 4, 7 or 8, the control device acquires information relating to the outdoor air temperature and/or outdoor air humidity at the end of the air preconditioning via an external network.

The vehicular air-conditioning device of the invention of claim 10 is characterized in the above respective inventions by including an electric heater to heat the air supplied to the vehicle interior and in that when the air preconditioning is executed in a state in which the battery is connected to the external power source, the control device stops the compressor and heats the vehicle interior by the electric heater.

The vehicular air-conditioning device of the invention of claim 11 is characterized in the inventions of claims 1 to 9 by including a waste heat recovering heat exchanger to recover waste heat from a heat generating device mounted on a vehicle by using the refrigerant and in that when the air preconditioning is executed in a state in which the battery is connected to the external power source, the control device operates the compressor, lets the refrigerant discharged from the compressor radiate heat, decompresses the refrigerant from which the heat is radiated, and then lets the refrigerant absorb heat in the waste heat recovering heat exchanger.

### Advantageous Effect of the Invention

According to the present invention, there is provided a vehicular air-conditioning device which includes a compressor supplied with power from a battery to compress a refrigerant, a radiator to let the refrigerant radiate heat, thereby heating air to be supplied to a vehicle interior, an outdoor heat exchanger provided outside the vehicle interior, and a control device, and in which the battery is capable of being charged by an external power source, and the control device at least executes a heating operation to heat the vehicle interior by letting the refrigerant discharged from the compressor radiate heat in the radiator, decompressing the refrigerant from which the heat is radiated, and then letting the refrigerant absorb heat in the outdoor heat exchanger. In the vehicular air-conditioning device, the control device is capable of executing air preconditioning to preliminarily heat the vehicle interior before boarding, and when the air preconditioning is executed in a state in which the battery is connected to the external power source, the control device heats the vehicle interior without using the outdoor heat exchanger. Therefore, it becomes possible to preliminarily heat the vehicle interior without frost formation on the outdoor heat exchanger in the air preconditioning before boarding.

In the present invention, in addition to it, since the control device changes a target temperature for heating control in the air preconditioning in the direction of increasing from a reference value of the target temperature, it is possible to store heat in the air in the vehicle interior and parts inside a vehicle such as seats during the air preconditioning. That is, it is possible to reduce the load when executing the heating operation in which the outdoor heat exchanger absorbs heat from outdoor air during running or the like after disconnecting the battery and the external power source. Consequently, it becomes possible to reduce frost formation on the outdoor heat exchanger and extend a period during which the heating operation can be performed with high efficiency, particularly under a low outdoor air temperature environment.

In particular, as in the invention of claim 2, if the control device changes the time to start the air preconditioning in the direction of advancing the time as a difference between an outdoor air temperature and the reference value of the target temperature becomes larger, it becomes possible to store heat in the vehicle interior without hindrance in the air preconditioning even under an environment where the outdoor air temperature is low.

Further, as in the invention of claim 3, even if the control device changes a rise width of the target outlet temperature in the direction of increasing the rise width as the difference between the outdoor air temperature and the reference value of the target temperature increases, it becomes possible to store heat in the vehicle interior without any trouble by air preconditioning under an environment where the outdoor air temperature is low.

In this case, as in the invention of claim 4, if an outdoor air temperature at the end of the air preconditioning is adopted as the outdoor air temperature, it becomes possible to realize air preconditioning according to an outdoor air temperature at the time of boarding.

Further, as in the invention of claim 5, if the control device changes the time to start the air preconditioning in the direction of advancing the time as an outdoor air humidity becomes higher, it becomes possible to store heat in the vehicle interior without hindrance by air preconditioning and effectively reduce frost formation on the outdoor heat exchanger 7 during subsequent running, under an environment in which the outdoor air humidity is high and the outdoor heat exchanger is likely to be frosted.

In addition, as in the invention of claim 6, even if the control device changes the rise width of the target temperature in the direction of increasing the rise width as the outdoor air humidity increases, it becomes possible to store heat in the vehicle interior without hindrance by the air preconditioning and effectively reduce frost formation on the outdoor heat exchanger during the subsequent running, under an environment where frost is likely to be formed on the outdoor heat exchanger.

Even in this case, as in the invention of claim 7, if an outdoor air humidity at the end of the air preconditioning is adopted as the outdoor air humidity, it becomes possible to realize air preconditioning according to the outdoor air humidity when boarding.

Further, as in the invention of claim 8, if the control device calculates the reference value of the target temperature, based on the outdoor air temperature and/or outdoor air humidity at the end of the air preconditioning, it becomes possible to realize appropriate air preconditioning according to the outdoor air temperature and the outdoor air humidity at the time of boarding.

In this case, as in the invention of claim 9, the control device acquires information relating to the outdoor air temperature and the outdoor air humidity at the end of the air preconditioning via an external network, thereby making it possible to realize without hindrance, air preconditioning corresponding to an outdoor air temperature and an outdoor air humidity at the time of boarding.

Incidentally, as the heating in the vehicle interior in which the outdoor heat exchanger is not used, there are considered a case where an electric heater is used as in the invention of claim 10, or one in which waste heat is recovered from a heat generating device mounted on the vehicle as in the invention of claim 11.

### BRIEF DESCRIPTION OF THE DRAWINGS

FIG. 1 is a constitutional view of a vehicular air-conditioning device of an embodiment to which the present invention is applied;

FIG. 2 is a block diagram of a controller as a control device of the vehicular air-conditioning device of FIG. 1;

FIG. 3 is a diagram describing a normal heating mode of a heating operation and a defrosting operation by the controller of FIG. 2;

FIG. 4 is a diagram describing a dehumidifying and heating operation by the controller of FIG. 2;

FIG. 5 is a diagram describing a dehumidifying and cooling operation and a cooling operation by the controller of FIG. 2;

FIG. 6 is a diagram describing a waste heat recovering and heating mode of a heating operation by the controller of FIG. 2;

FIG. 7 is a control block diagram regarding compressor control in the heating operation of the controller of FIG. 2;

FIG. 8 is a control block diagram regarding auxiliary heater (electric heater) control by the controller of FIG. 2;

FIG. 9 is a control block diagram of air preconditioning by the controller of FIG. 2; and

FIG. 10 is a flowchart describing control of air preconditioning by the controller of FIG. 2.

### MODE FOR CARRYING OUT THE INVENTION

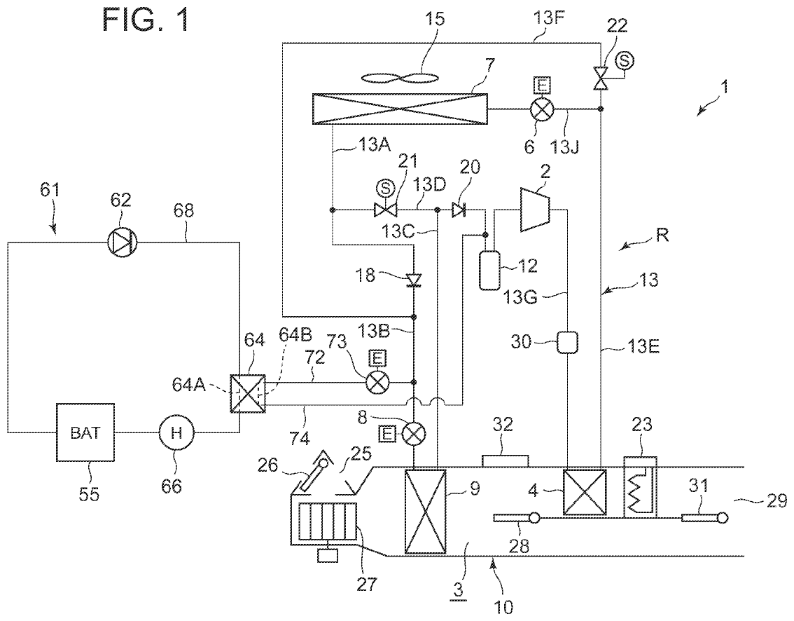

Hereinafter, embodiments of the present invention will be described in detail based on the drawings. FIG. 1 illustrates a constitutional view of a vehicular air-conditioning device 1 of an embodiment to which the present invention is applied. A vehicle of the embodiment to which the present invention is applied is an electric vehicle (EV) in which an engine (an internal combustion engine) is not mounted, and is mounted with a battery 55 (e.g., a lithium battery) and runs with a motor for running (not shown in the drawing) which is driven by being supplied with power charged in the battery 55 from an external power source (a quick charger or the like). Then, a compressor 2 to be described later in the vehicular air-conditioning device 1 is also driven by being supplied with power from the battery 55.

That is, in the electric vehicle which is not capable of performing heating by engine waste heat, the vehicular air-conditioning device 1 performs a heating operation by a heat pump operation in which a refrigerant circuit R is used. Further, the vehicular air-conditioning device 1 selectively executes respective air conditioning operations of a dehumidifying and heating operation, a dehumidifying and cooling operation, and a cooling operation to perform air conditioning of a vehicle interior.

Incidentally, the vehicle is not limited to such an electric vehicle. It is needless to say that the present invention is also effective for a vehicle which is a so-called hybrid car in which an engine is used together with an electric motor for running, and in which a battery can be charged from an external power source.

The vehicular air-conditioning device 1 of the embodiment performs air conditioning (heating, cooling, dehumidifying, and ventilation) of the vehicle interior of the electric vehicle. The electric type of compressor (electric compressor) 2 to compress a refrigerant, a radiator 4 which is provided in an air flow passage 3 of an HVAC unit 10 in which air in the vehicle interior is ventilated and circulated, to let the high-temperature high-pressure refrigerant discharged from the compressor 2 flow therein via a refrigerant pipe 13G and to let the refrigerant radiate heat to heat the air supplied to the vehicle interior, an outdoor expansion valve 6 constituted of an electric valve which decompresses and expands the refrigerant during the heating, an outdoor heat exchanger 7 for causing the refrigerant to perform heat exchange with outdoor air to function as a radiator (condenser) to let the refrigerant radiate heat during the cooling and to function as an evaporator to let the refrigerant absorb heat during the heating, an indoor expansion valve 8 constituted of an electric valve to decompress and expand the refrigerant, a heat absorber 9 provided in the air flow passage 3 to let the refrigerant absorb heat from the interior and exterior of the vehicle during the cooling (during dehumidifying), thereby cooling the air supplied to the vehicle interior, an accumulator 12, and others are successively connected by a refrigerant pipe 13, whereby the refrigerant circuit R is constituted.

The outdoor expansion valve 6 and the indoor expansion valve 8 decompress and expand the refrigerant and can also be fully opened and closed. 30 in the drawing is a strainer.

Incidentally, the outdoor heat exchanger 7 is provided with an outdoor blower 15. The outdoor blower 15 forcibly passes the outdoor air through the outdoor heat exchanger 7 to thereby perform heat exchange between the outdoor air and the refrigerant, whereby the outdoor air is made to pass through the outdoor heat exchanger 7 even during stopping of the vehicle (i.e., its velocity is 0 km/h).

Also, a refrigerant pipe 13A connected to the refrigerant outlet side of the outdoor heat exchanger 7 is connected to a refrigerant pipe 13B through a check valve 18. Incidentally, the check valve 18 is configured such that the refrigerant pipe 13B side serves as a forward direction. The refrigerant pipe 13B is connected to the indoor expansion valve 8.

Further, the refrigerant pipe 13A extending out from the outdoor heat exchanger 7 branches and this branching refrigerant pipe 13D communicates and connects with a refrigerant pipe 13C located on an outlet side of the heat absorber 9 via a solenoid valve 21 to be opened during the heating. Then, a check valve 20 is connected to the refrigerant pipe 13C on a downstream side from a connecting point of the refrigerant pipe 13D. The refrigerant pipe 13C on a downstream side from the check valve 20 is connected to the accumulator 12. The accumulator 12 is connected to a refrigerant suction side of the compressor 2. Incidentally, the check valve 20 includes an accumulator 12 side which serves as a forward direction.

Furthermore, a refrigerant pipe 13E on an outlet side of the radiator 4 branches to a refrigerant pipe 13J and a refrigerant pipe 13F before the outdoor expansion valve 6 (on a refrigerant upstream side). One branching refrigerant pipe 13J is connected to a refrigerant inlet side of the outdoor heat exchanger 7 via the outdoor expansion valve 6. Additionally, the other branching refrigerant pipe 13F communicates and connects with the refrigerant pipe 13B located on a refrigerant downstream side of the check valve 18 via a solenoid valve 22 to be opened during the dehumidifying and on a refrigerant upstream side of the indoor expansion valve 8.

Consequently, the refrigerant pipe 13F is connected in parallel with a series circuit of the outdoor expansion valve 6, the outdoor heat exchanger 7, and the check valve 18. The refrigerant pipe 13F becomes a circuit which bypasses the outdoor expansion valve 6, the outdoor heat exchanger 7, and the check valve 18.

Also, in the air flow passage 3 on an air upstream side of the heat absorber 9, respective suction ports such as an outdoor air suction port and an indoor air suction port are formed (represented by a suction port 25 in FIG. 1), and in the suction port 25, an air inlet changing damper 26 is provided to change the air to be introduced into the air flow passage 3 to indoor air which is air of the vehicle interior (indoor air circulation) and outdoor air which is air outside the vehicle interior (outdoor air introduction). Further, an indoor blower (a blower fan) 27 to supply the introduced indoor or outdoor air to the air flow passage 3 is provided on an air downstream side of the air inlet changing damper 26.

Further, in FIG. 1, 23 is an auxiliary heater as the electric heater. In the embodiment, the auxiliary heater 23 is constituted of a PTC heater and provided in the air flow passage 3 which becomes an air downstream side of the radiator 4 with respect to the flow of the air in the air flow passage 3. Then, when the auxiliary heater 23 is energized to generate heat, this becomes a so-called heater core.

Additionally, in the air flow passage 3 on an air upstream side of the radiator 4, there is provided an air mix damper 28 to adjust a ratio at which the air in the air flow passage 3 (the indoor or outdoor air) flowing into the air flow passage 3 and passed through the heat absorber 9 is to be passed through the radiator 4 and the auxiliary heater 23. Further, in the air flow passage 3 on the air downstream side of the radiator 4, there is formed each outlet (represented by an outlet 29 in FIG. 1) of FOOT (foot), VENT (vent) or DEF (defroster). In the outlet 29, there is provided an air outlet changing damper 31 to execute changing control of blowing of the air from each outlet mentioned above.

Furthermore, the vehicular air-conditioning device 1 is provided with a waste heat recovering device 61 for circulating a heat medium through the battery 55 as a heat generating device mounted on the vehicle to adjust the temperature of the battery 55 while receiving waste heat from the battery 55.

Incidentally, the heat generating device mounted on the vehicle in the present invention is not limited to the battery 55 and also includes a motor for running and an electrical device such as an inverter circuit for driving the motor. In the embodiment, the heat generating device will be described by taking the battery 55 as an example.

The waste heat recovering device 61 of the embodiment includes a circulating pump 62 as a circulation device to circulate the heat medium through the battery 55, a heat medium heating heater 66 as a heating device, and a refrigerant-heat medium heat exchanger 64 as a waste heat recovering heat exchanger. Those and the battery 55 are annularly connected by a heat medium pipe 68.

In the case of the embodiment, an inlet of a heat medium flow passage 64A of the refrigerant-heat medium heat exchanger 64 is connected to a discharge side of the circulating pump 62. The heat medium heating heater 66 is connected to an outlet of the heat medium flow passage 64A. An inlet of the battery 55 is connected to an outlet of the heat medium heating heater 66. An outlet of the battery 55 is connected to a suction side of the circulating pump 62.

As the heat medium used in the waste heat recovering device 61, for example, water, a refrigerant such as HFO-1234f, liquid such as a coolant or the like, or gas such as air or the like can be adopted. Incidentally, in the embodiment, water is used as the heat medium. Also, the heat medium heating heater 66 is constituted of an electric heater such as a PTC heater or the like. Further, it is assumed that, for example, a jacket structure capable of circulating the heat medium in a heat exchange relation with the battery 55 is applied around the battery 55.

Then, when the circulating pump 62 is operated, the heat medium discharged from the circulating pump 62 flows into the heat medium flow passage 64A of the refrigerant-heat medium heat exchanger 64. The heat medium flowing out from the heat medium flow passage 64A of the refrigerant-heat medium heat exchanger 64 reaches the heat medium heating heater 66. When the heat medium heating heater 66 generates heat, the heat medium is heated thereat and then reaches the battery 55. The heat medium performs heat exchange with the battery 55 thereat. Then, the heat medium is sucked into the circulating pump 62 to be circulated in the heat medium pipe 68.

On the other hand, one end of a branch pipe 72 as a branch circuit is connected to an outlet of the refrigerant pipe 13F of the refrigerant circuit R, i.e., a connecting portion of the refrigerant pipe 13F and the refrigerant pipe 13B so as to be located on a refrigerant downstream side (forward direction side) of the check valve 18 located in the refrigerant pipe 13A and on a refrigerant upstream side of the indoor expansion valve 8. The branch pipe 72 is provided with an auxiliary expansion valve 73 constituted of an electric valve. The auxiliary expansion valve 73 decompresses and expands the refrigerant flowing into a refrigerant flow passage 64B to be described later of the refrigerant-heat medium heat exchanger 64 and can also be fully closed.

Then, the other end of the branch pipe 72 is connected to the refrigerant flow passage 64B of the refrigerant-heat medium heat exchanger 64. One end of a refrigerant pipe 74 is connected to an outlet of the refrigerant flow passage 64B, and the other end of the refrigerant pipe 74 is connected to the refrigerant pipe 13C on the refrigerant downstream side of the check valve 20 and before the accumulator 12 (on the refrigerant upstream side). Then, the auxiliary expansion valve 73 and the like of these also constitute a part of the refrigerant circuit R and simultaneously also constitute a part of the waste heat recovering device 61.

When the auxiliary expansion valve 73 is opened, the refrigerant (some or all refrigerant) flowing out from the refrigerant pipe 13F and the outdoor heat exchanger 7 is decompressed by the auxiliary expansion valve 73 and then flows into the refrigerant flow passage 64B of the refrigerant-heat medium heat exchanger 64 to evaporate there. The refrigerant absorbs heat from the heat medium flowing through the heat medium flow passage 64A in the process of flowing through the refrigerant flow passage 64B, followed by being sucked into the compressor 2 via the accumulator 12.

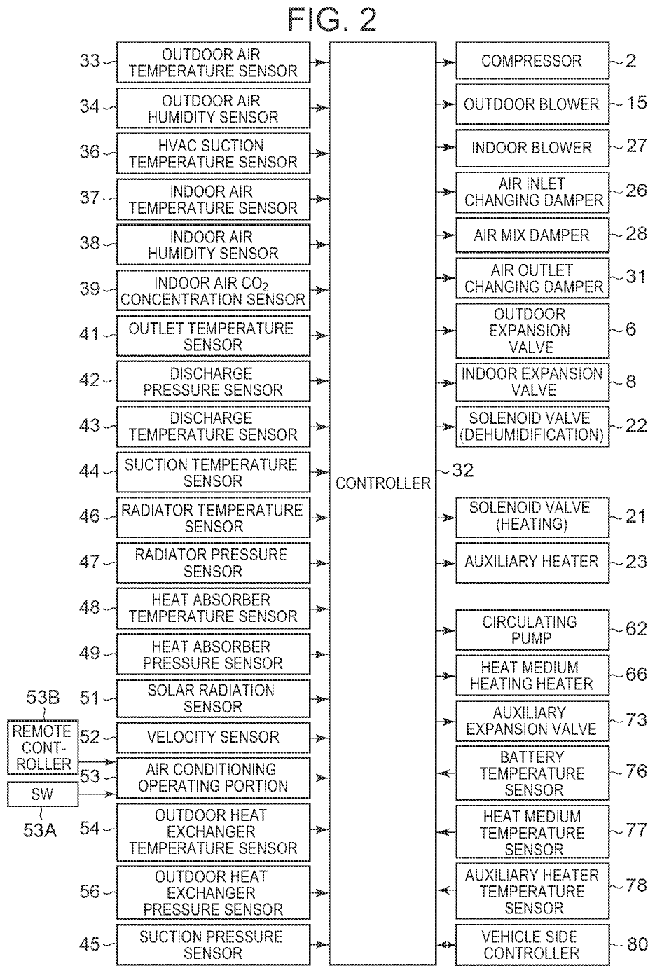

Next, in FIG. 2, 32 is a controller as a control device which performs control of the vehicular air-conditioning device 1. The controller 32 is constituted of a microcomputer as an example of a computer including a processor. An input of the controller 32 (control device) is connected with respective outputs of an outdoor air temperature sensor 33 which detects an outdoor air temperature (Tam) of the vehicle, an outdoor air humidity sensor 34 which detects an outdoor air humidity (Ham), an HVAC suction temperature sensor 36 which detects a temperature of the air to be sucked from the suction port 25 to the air flow passage 3, an indoor air temperature sensor 37 which detects a temperature (indoor air temperature Tin) of the air (indoor air) of the vehicle interior, an indoor air humidity sensor 38 which detects a humidity of the air of the vehicle interior, an indoor air CO₂ concentration sensor 39 which detects a carbon dioxide concentration of the vehicle interior, an outlet temperature sensor 41 which detects a temperature of the air to be blown out from the outlet 29 to the vehicle interior, a discharge pressure sensor 42 which detects a discharge refrigerant pressure Pd of the compressor 2, a discharge temperature sensor 43 which detects a discharge refrigerant temperature of the compressor 2, a suction temperature sensor 44 which detects a suction refrigerant temperature Ts of the compressor 2, a suction pressure sensor 45 which detects a suction refrigerant pressure Ps of the compressor 2, a radiator temperature sensor 46 which detects a temperature (the temperature of the air passed through the radiator 4 or the temperature of the radiator 4 itself: a radiator temperature TCI) of the radiator 4, a radiator pressure sensor 47 which detects a refrigerant pressure (the pressure of the refrigerant in the radiator 4 or immediately after the refrigerant flows out from the radiator 4: a radiator pressure PCI) of the radiator 4, a heat absorber temperature sensor 48 which detects a temperature (the temperature of the air passed through the heat absorber 9 or the temperature of the heat absorber 9 itself: a heat absorber temperature Te) of the heat absorber 9, a heat absorber pressure sensor 49 which detects a refrigerant pressure (the pressure of the refrigerant in the heat absorber 9 or immediately after the refrigerant flows out from the heat absorber 9) of the heat absorber 9, a solar radiation sensor 51 of, e.g., a photo sensor system to detect a solar radiation amount into the vehicle interior, a velocity sensor 52 to detect a moving speed (a velocity) of the vehicle, an air conditioning operating portion 53 to set the changing of a predetermined temperature or an air conditioning operation, an outdoor heat exchanger temperature sensor 54 which detects a temperature (the temperature of the refrigerant immediately after the refrigerant flows out from the outdoor heat exchanger 7, or the temperature of the outdoor heat exchanger 7 itself: an outdoor heat exchanger temperature TXO. When the outdoor heat exchanger 7 functions as an evaporator, the outdoor heat exchanger temperature TXO becomes an evaporation temperature of the refrigerant in the outdoor heat exchanger 7) of the outdoor heat exchanger 7, and an outdoor heat exchanger pressure sensor 56 which detects a refrigerant pressure (the pressure of the refrigerant in the outdoor heat exchanger 7 or immediately after the refrigerant flows out from the outdoor heat exchanger 7) of the outdoor heat exchanger 7.

In the drawing, 53A is a switch for input provided in the air conditioning operating portion 53. Further, the air conditioning operating portion 53 is configured such that air preconditioning predictive information from a remote controller 53B provided in a vehicle key is wirelessly input.

The input of the controller 32 is further connected also with respective outputs of a battery temperature sensor 76 which detects a temperature (a battery temperature Tcell) of the battery 55, a heat medium temperature sensor 77 which detects a temperature (a heat medium temperature Tw) of the heat medium flowing out from the heat medium flow passage 64A of the refrigerant-heat medium heat exchanger 64, and an auxiliary heater temperature sensor 78 which detects a temperature (an auxiliary heater temperature Tptc) of the auxiliary heater 23.

On the other hand, an output of the controller 32 is connected with the compressor 2, the outdoor blower 15, the indoor blower (the blower fan) 27, the air inlet changing damper 26, the air mix damper 28, the air outlet changing damper 31, the outdoor expansion valve 6, the indoor expansion valve 8, the respective solenoid valves of the solenoid valve 22 (dehumidification) and the solenoid valve 21 (heating), the auxiliary heater 23, the circulating pump 62, the heat medium heating heater 66, and the auxiliary expansion valve 73.

Furthermore, the controller 32 performs transmission/reception of data to and from a vehicle side controller 80 which performs control of the entire vehicle such as running, charging of the battery 55, etc. Then, in regard to the controller 32, information as to whether or not a charging plug for the external power source (quick charger or the like) is connected to the vehicle from the vehicle side controller 80, information as to whether or not the battery 55 is being charged, and predictive information about the outdoor air temperature Tam and the outdoor air humidity Ham acquired via an external network such as Internet or the like are input to the controller 32. Then, on the basis of the outputs of the respective sensors, the information from the vehicle side controller 80, the setting information input at the air conditioning operating portion 53, etc., the controller 32 controls these.

Next, an operation of the vehicular air-conditioning device 1 of the embodiment will be described with the above constitution. In the embodiment, the controller 32 (control device) changes and executes the respective air conditioning operations of the heating operation, the dehumidifying and heating operation, the dehumidifying and cooling operation, the cooling operation, and the auxiliary heater single operation, and the defrosting operation, recovers waste heat from the battery 55 (heat generating device), and adjusts the temperature of the battery 55. Description will initially be made as to each air conditioning operation of the refrigerant circuit R in the vehicular air-conditioning device 1. Incidentally, the controller 32 operates the circulating pump 62 during the operation of the vehicular air-conditioning device 1. Thus, it is assumed that the heat medium is circulated in the heat medium pipe 68 as indicated by broken line arrows in each drawing.

(1) Heating Operation (Normal Heating Mode)

Description will first be made as to the heating operation. During the heating operation, the controller 32 changes and executes two operation modes of a normal heating mode and a waste heat recovery heating mode as will be described later. The normal heating mode will be described herein, and the waste heat recovery heating mode will be described later.

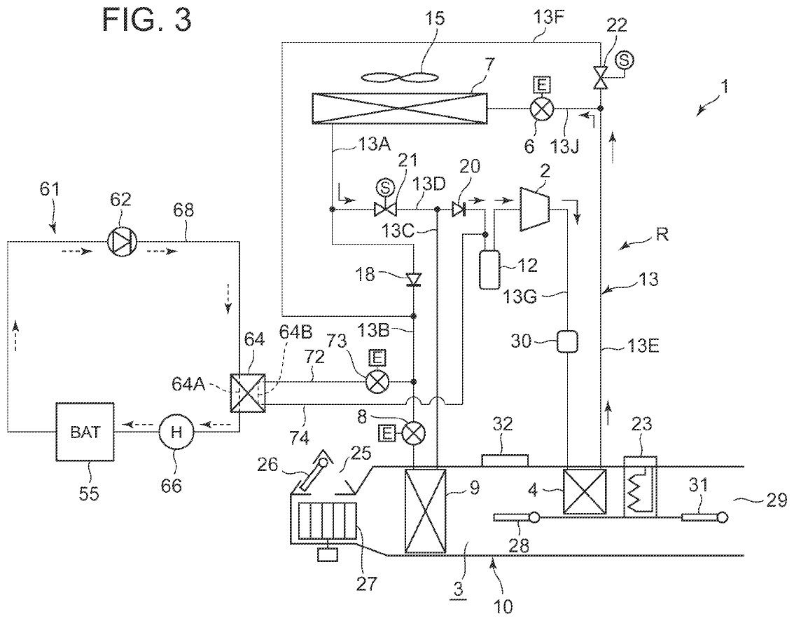

FIG. 3 shows the flow (solid line arrows) of the refrigerant of the refrigerant circuit R in the normal heating mode of the heating operation. In winter or the like, when the air conditioning switch included in the switch 53A of the air conditioning operating portion 53 is turned ON, and the heating operation is selected by the controller 32 (an automatic mode) or a manual operation to the air conditioning operating portion 53 (a manual mode), the controller 32 opens the solenoid valve 21 (for the heating) and fully closes the indoor expansion valve 8 and the auxiliary expansion valve 73 in the normal heating mode. Consequently, the inflow of the refrigerant into the refrigerant-heat medium heat exchanger 64 is prohibited. Further, the controller closes the solenoid valve 22 (for the dehumidification).

Then, the controller operates the compressor 2 and the respective blowers 15 and 27, and the air mix damper 28 holds a state of adjusting a ratio at which the air blown out from the indoor blower 27 is to be passed through the radiator 4 and the auxiliary heater 23. In consequence, a high-temperature high-pressure gas refrigerant discharged from the compressor 2 flows into the radiator 4. The air in the air flow passage 3 passes through the radiator 4, and hence the air in the air flow passage 3 is heated by the high-temperature refrigerant in the radiator 4. On the other hand, the refrigerant in the radiator 4 has the heat taken by the air and is cooled to condense and liquefy.

The refrigerant liquefied in the radiator 4 flows out from the radiator 4 and then flows through the refrigerant pipes 13E and 13J to reach the outdoor expansion valve 6. The refrigerant flowing into the outdoor expansion valve 6 is decompressed therein, and then flows into the outdoor heat exchanger 7. The refrigerant flowing into the outdoor heat exchanger 7 evaporates, and the heat is pumped up from the outdoor air passed by running or the outdoor blower 15 (heat absorption). That is, the refrigerant circuit R functions as a heat pump. Then, the low-temperature refrigerant flowing out from the outdoor heat exchanger 7 reaches the refrigerant pipe 13C through the refrigerant pipe 13A and the refrigerant pipe 13D, and the solenoid valve 21, and flows into the accumulator 12 via the check valve 20 in the refrigerant pipe 13C to perform gas-liquid separation therein, and the gas refrigerant is then sucked into the compressor 2, thereby repeating this circulation. The air heated in the radiator 4 is blown out from the outlet 29, thereby performing the heating of the vehicle interior.

The controller 32 calculates a target radiator pressure PCO (a target value of the pressure PCI of the radiator 4) from a target heater temperature TCO (a target value of an air temperature on the leeward side of the radiator 4) calculated from an after-mentioned target outlet temperature TAO, and controls the number of revolutions of the compressor 2 on the basis of the target radiator pressure PCO and the refrigerant pressure of the radiator 4 which is detected by the radiator pressure sensor 47 (the radiator pressure PCI that is a high pressure of the refrigerant circuit R). Further, the controller controls a valve position of the outdoor expansion valve 6 on the basis of the temperature (the radiator temperature TCI) of the radiator 4 which is detected by the radiator temperature sensor 46 and the radiator pressure PCI detected by the radiator pressure sensor 47, and controls a subcool degree of the refrigerant in an outlet of the radiator 4. Further, when the heating capacity by the radiator 4 is insufficient, the auxiliary heater 23 is energized to generate heat, thereby supplementing the heating capacity.

(2) Dehumidifying and Heating Operation

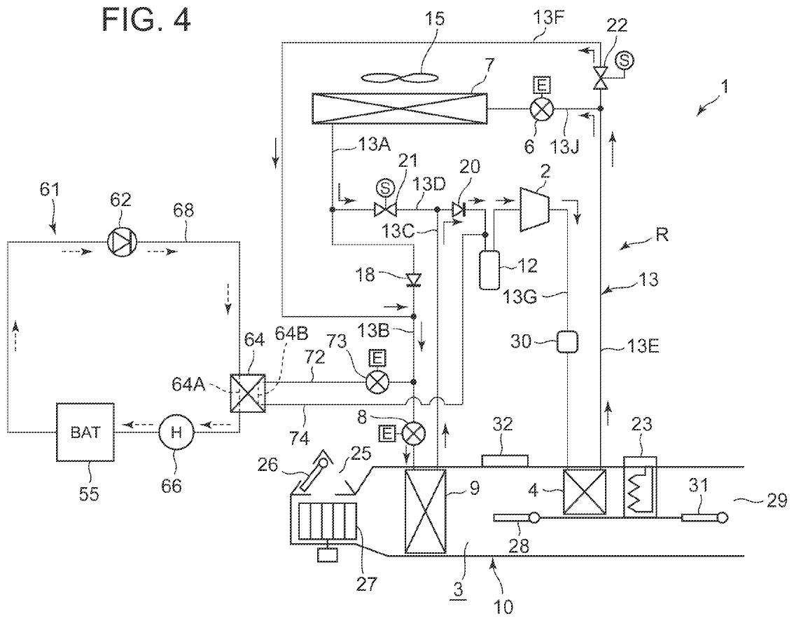

Next, description will be made as to the dehumidifying and heating operation with reference to FIG. 4. FIG. 4 shows the flow (solid line arrows) of the refrigerant of the refrigerant circuit R in the dehumidifying and heating operation. In the dehumidifying and heating operation, the controller 32 opens the solenoid valve 22 in the above state of the heating operation and opens the indoor expansion valve 8 to set the refrigerant to its decompressed and expanded state. Consequently, a part of the condensed refrigerant flowing into the refrigerant pipe 13E through the radiator 4 is distributed, the distributed refrigerant flows through the solenoid valve 22 into the refrigerant pipe 13F and flows from the refrigerant pipe 13B into the indoor expansion valve 8, and the residual refrigerant flows through the outdoor expansion valve 6. That is, the distributed part of the refrigerant is decompressed in the indoor expansion valve 8, and then flows into the heat absorber 9 to evaporate.

The controller 32 controls a valve position of the indoor expansion valve 8 to maintain a superheat degree (SH) of the refrigerant in an outlet of the heat absorber 9 at a predetermined value, but water in the air blown out from the indoor blower 27 coagulates to adhere to the heat absorber 9 by a heat absorbing operation of the refrigerant which occurs in the heat absorber 9 at this time, and hence, the air is cooled and dehumidified. The distributed residual refrigerant flowing into the refrigerant pipe 13J is decompressed in the outdoor expansion valve 6, and then evaporates in the outdoor heat exchanger 7.

The refrigerant evaporated in the heat absorber 9 flows out to the refrigerant pipe 13C to join the refrigerant (the refrigerant from the outdoor heat exchanger 7) from the refrigerant pipe 13D, and then flows through the check valve 20 and the accumulator 12 to be sucked into the compressor 2, thereby repeating this circulation. The air dehumidified in the heat absorber 9 is reheated in the process of passing the radiator 4, thereby performing the dehumidifying and heating of the vehicle interior.

The controller 32 controls the number of revolutions of the compressor 2 on the basis of the target radiator pressure PCO calculated from the target heater temperature TCO and the radiator pressure PCI (the high pressure of the refrigerant circuit R) detected by the radiator pressure sensor 47, and the controller 32 controls the valve position of the outdoor expansion valve 6 on the basis of the temperature (the heat absorber temperature Te) of the heat absorber 9 which is detected by the heat absorber temperature sensor 48.

(3) Dehumidifying and Cooling Operation

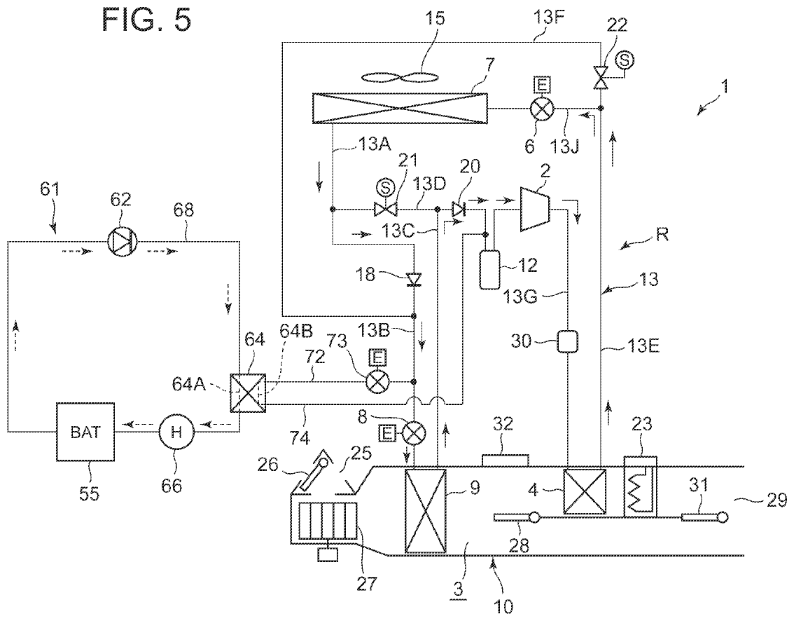

Next, description will be made as to the dehumidifying and cooling operation with reference to FIG. 5. FIG. 5 shows the flow (solid line arrows) of the refrigerant of the refrigerant circuit R in the dehumidifying and cooling operation. In the dehumidifying and cooling operation, the controller 32 opens the indoor expansion valve 8 to bring the refrigerant into a decompressed and expanded state, and closes the solenoid valve 21 and the solenoid valve 22. Further, the controller also fully closes the auxiliary expansion valve 73. Then, the controller operates the compressor 2 and the respective blowers 15 and 27, and the air mix damper 28 holds a state of adjusting a ratio at which the air blown out from the indoor blower 27 is to be passed through the radiator 4 and the auxiliary heater 23.

Consequently, a high-temperature high-pressure gas refrigerant discharged from the compressor 2 flows into the radiator 4. Since the air in the air flow passage 3 passes through the radiator 4, the air in the air flow passage 3 is heated by the high-temperature refrigerant in the radiator 4. On the other hand, the refrigerant in the radiator 4 has the heat taken by the air and is cooled to condense and liquefy.

The refrigerant flowing out from the radiator 4 flows through the refrigerant pipe 13E to reach the outdoor expansion valve 6, and flows through the outdoor expansion valve 6 controlled to slightly open, to flow into the outdoor heat exchanger 7. The refrigerant flowing into the outdoor heat exchanger 7 is cooled by the running therein or the outdoor air passed through the outdoor blower 15 to condense. The refrigerant flowing out from the outdoor heat exchanger 7 flows through the refrigerant pipe 13A and the check valve 18 to enter the refrigerant pipe 13B and reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence, the air is cooled and dehumidified.

The refrigerant evaporated in the heat absorber 9 flows through the refrigerant pipe 13C and the check valve 20 to reach the accumulator 12, and flows therethrough to be sucked into the compressor 2, thereby repeating this circulation. The air cooled and dehumidified in the heat absorber 9 is reheated in the process of passing the radiator 4 (reheating: a radiation capability is lower than that during the heating), thereby performing the dehumidifying and cooling of the vehicle interior.

The controller 32 controls, based on the temperature (the heat absorber temperature Te) of the heat absorber 9 which is detected by the heat absorber temperature sensor 48, and a target heat absorber temperature TEO being its target value, the number of revolutions of the compressor 2 to set the heat absorber temperature Te to the target heat absorber temperature TEO, and controls, based on the radiator pressure PCI (the high pressure of the refrigerant circuit R) detected by the radiator pressure sensor 47 and the target radiator pressure PCO (the target value of the radiator pressure PCI) calculated from the target heater temperature TCO, the valve position of the outdoor expansion valve 6 to set the radiator pressure PCI to the target radiator pressure PCO, thereby obtaining a required amount of reheat by the radiator 4.

(4) Cooling Operation

Next, description will be made as to the cooling operation. The flow of the refrigerant circuit R is similar to that in the dehumidifying and cooling operation of FIG. 5. In the cooling operation executed in summer or the like, the controller 32 fully opens the valve position of the outdoor expansion valve 6 in the above state of the dehumidifying and cooling operation. Incidentally, the air mix damper 28 holds a state of adjusting a ratio at which the air is to be passed through the radiator 4 and the auxiliary heater 23.

Consequently, the high-temperature high-pressure gas refrigerant discharged from the compressor 2 flows into the radiator 4. The air in the air flow passage 3 is passed through the radiator 4 but its ratio becomes small (because of only reheat during the cooling). Therefore, the refrigerant almost only passes the radiator, and the refrigerant flowing out from the radiator 4 flows through the refrigerant pipe 13E to reach the outdoor expansion valve 6. At this time, the outdoor expansion valve 6 is fully opened, and hence, the refrigerant passes the refrigerant pipe 13J through the outdoor expansion valve 6 as it is, and flows into the outdoor heat exchanger 7, in which the refrigerant is cooled by the running therein or the outdoor air to pass through the outdoor blower 15, to condense and liquefy.

The refrigerant flowing out from the outdoor heat exchanger 7 flows through the refrigerant pipe 13A and the check valve 18 to enter the refrigerant pipe 13B, and reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence, the air is cooled.

The refrigerant evaporated in the heat absorber 9 flows through the refrigerant pipe 13C and the check valve 20 to reach the accumulator 12, and flows therethrough to be sucked into the compressor 2, thereby repeating this circulation. The air cooled and dehumidified in the heat absorber 9 is blown out from the outlet 29 to the vehicle interior, thereby performing the cooling of the vehicle interior. In this cooling operation, the controller 32 controls the number of revolutions of the compressor 2 on the basis of the temperature (the heat absorber temperature Te) of the heat absorber 9 which is detected by the heat absorber temperature sensor 48.

(5) Auxiliary Heater Single Operation

The controller 32 of the embodiment has an auxiliary heater independent operation of in the case where excessive frosting occurs in the outdoor heat exchanger 7 or where the vehicle interior is heated by air preconditioning to be described later, etc., stopping the compressor 2 and the outdoor blower 15 in the refrigerant circuit R, energizing the auxiliary heater 23 to heat the vehicle interior only by the auxiliary heater 23. Even in this case, the controller 32 controls the energization (heat generation) of the auxiliary heater 23 based on the auxiliary heater temperature Tptc detected by the auxiliary heater temperature sensor 78 and the target heater temperature TCO.

Further, the controller 32 operates the indoor blower 27, and the air mix damper 28 has a state of ventilating the air in the air flow passage 3 blown out from the indoor blower 27 to the auxiliary heater 23 to adjust an air volume. The air heated by the auxiliary heater 23 is blown out from the outlet 29 into the vehicle interior, the compressor 2 is stopped, and the refrigerant does not flow into the outdoor heat exchanger 7, so that the interior of the vehicle is heated without using the outdoor heat exchanger 7.

(6) Changing of Air Conditioning Operation

The controller 32 calculates the above-mentioned target outlet temperature TAO from the following equation (I). The target outlet temperature TAO is a target value of the temperature of the air to be blown out from the outlet 29 to the vehicle interior.

TAO=(Tset−Tin)×K+Tbal(f(Tset,SUN,Tam)) (I)

where Tin is a temperature (an indoor air temperature) of the vehicle interior air which is detected by the indoor air temperature sensor 37, Tset is a predetermined temperature (a target vehicle interior air temperature) of the indoor air temperature Tin (the temperature of the vehicle interior air), which is set by the air conditioning operating portion 53, K is a coefficient, and Tbal is a balance value calculated from the target vehicle interior air temperature Tset, a solar radiation amount SUN detected by the solar radiation sensor 51, and the outdoor air temperature Tam detected by the outdoor air temperature sensor 33. Further, in general, the lower the outdoor air temperature Tam is, the higher the target outlet temperature TAO becomes, and the higher the outdoor air temperature Tam becomes, the lower the target outlet temperature TAO becomes.

Further, the controller 32 calculates the above-mentioned target heater temperature TCO by using the following equation (II) on the basis of the target outlet temperature TAO:

TCO=f(TAO) (II)

Incidentally, f in the above equation (II) means a limit of controlling or an offset or the like. However, since TCO=TAO basically, the target heater temperature TCO also rises if the target outlet temperature TAO rises, and the target heater temperature TCO also decreases if the target outlet temperature TAO is lowered.

Then, the controller 32 selects any air conditioning operation from the above respective air conditioning operations on the basis of the outdoor air temperature Tam detected by the outdoor air temperature sensor 33 and the target outlet temperature TAO on startup. Further, after the startup, the controller selects and changes the above respective air conditioning operations in accordance with changes of environments and setting conditions such as the outdoor air temperature Tam and the target outlet temperature TAO.

(7) Defrosting Operation

Next, the defrosting operation of the outdoor heat exchanger 7 will be described. In the heating operation as described above, the refrigerant evaporates in the outdoor heat exchanger 7 and absorbs heat from the outdoor air to be low in temperature. Therefore, the water in the outdoor air grows into frost in the outdoor heat exchanger 7, which adheres thereto.

Thus, the controller 32 calculates a difference ATXO (=TXObase−TXO) between the outdoor heat exchanger temperature TXO (the refrigerant evaporation temperature in the outdoor heat exchanger 7) detected by the outdoor heat exchanger temperature sensor 54, and a refrigerant evaporation temperature TXObase in non-frosting of the outdoor heat exchanger 7. When a state in which the outdoor heat exchanger temperature TXO is lowered than the refrigerant evaporation temperature TXObase in non-frosting, and the difference ATXO therebetween has expanded to a predetermined value or more, continues for a predetermined time, the controller 32 judges that the outdoor heat exchanger 7 is frosted, and sets a predetermined frosting flag.

Then, in the state in which the frosting flag is set and the air conditioning switch of the air conditioning operating portion 53 is turned OFF, when the charging plug for the external power source (the quick charger or the like) is connected to the vehicle, and the battery 55 is charged, the controller 32 executes the defrosting operation of the outdoor heat exchanger 7 in the following manner.

In this defrosting operation, the controller 32 sets the refrigerant circuit R to the state of the heating operation described above, and then fully opens the valve position of the outdoor expansion valve 6. Then, the controller 32 operates the compressor 2, causes the high-temperature refrigerant discharged from the compressor 2 to flow into the outdoor heat exchanger 7 via the radiator 4 and the outdoor expansion valve 6 to thereby let the refrigerant radiate heat. Consequently, the frost adhered to the outdoor heat exchanger 7 is melted. Then, when the outdoor heat exchanger temperature TXO detected by the outdoor heat exchanger temperature sensor 54 becomes higher than a predetermined defrosting end temperature (e.g., +3° C. or the like), the controller 32 terminates the defrosting operation assuming the defrosting of the outdoor heat exchanger 7 has been completed.

(8) Waste heat Recovery Heating Mode in Heating Operation

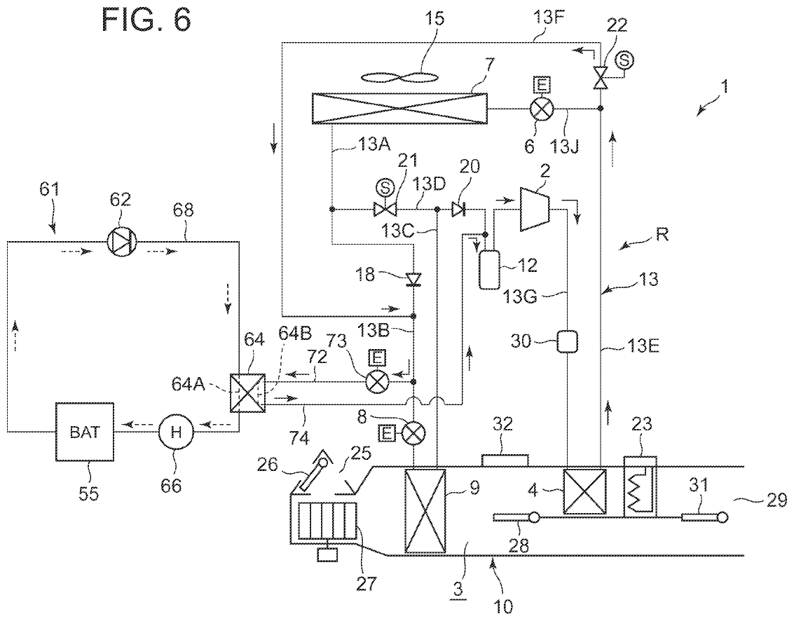

Next, description will be made as to a waste heat recovery heating mode in the heating operation with reference to FIG. 6. Here, the battery 55 rises in temperature due to its self-heat generation. Thus, the controller 32 executes the waste heat recovery heating mode instead of the above-mentioned normal heating mode where the temperature (judged from the above-described heat medium temperature Tw and battery temperature Tcell) of the battery 55 in the heating operation, or in air preconditioning to be described later. In the waste heat recovery heating mode, the waste heat of the battery 55 is recovered and used in heating of the vehicle interior in the radiator 4.

FIG. 6 shows the flow (solid line arrows) of the refrigerant of the refrigerant circuit R in the waste heat recovery heating mode. In the waste heat recovery heating mode, the controller 32 fully closes the outdoor expansion valve 6 and opens the solenoid valve 21. Consequently, the inflow of the refrigerant into the outdoor heat exchanger 7 is prohibited. On the other hand, the solenoid valve 22 is opened and the auxiliary expansion valve 73 is also opened to put its valve position in a controlled state. Incidentally, the heat medium heating heater 66 is caused to generate heat as needed.

Thus, all of the refrigerant discharged from the radiator 4 does not flow into the outdoor expansion valve 6, and flows through the refrigerant pipe 13F to reach the refrigerant pipe 13B on the refrigerant upstream side of the indoor expansion valve 8. Next, the refrigerant enters the branch pipe 72 and is decompressed by the auxiliary expansion valve 73, and then flows into the refrigerant flow passage 64B of the refrigerant-heat medium heat exchanger 64 through the branch pipe 72 to evaporate. At this time, the heat absorbing operation is exerted. A circulation is repeated in which the refrigerant evaporated in the refrigerant flow passage 64B flows through the refrigerant pipe 74, the refrigerant pipe 13C, and the accumulator 12 sequentially to be sucked into the compressor 2 (this is indicated by the solid line arrows in FIG. 6).

On the other hand, a circulation is performed in which the heat medium discharged from the circulating pump 62 flows in the heat medium pipe 68 in the order of the heat medium flow passage 64A of the refrigerant-heat medium heat exchanger 64, the heat medium heating heater 66, and the battery 55 to be sucked into the circulating pump 62 (this is indicated by broken line arrows in FIG. 6).

Thus, the heat medium that is made endothermic and cooled by the refrigerant in the heat medium flow passage 64A of the refrigerant-heat medium heat exchanger 64 is circulated to the battery 55 through the heat medium heating heater 66, and performs heat exchange with the battery 55 to recover the waste heat from the battery 55 and cool the battery 55. The waste heat recovered from the battery 55 is pumped up by the refrigerant in the refrigerant-heat medium heat exchanger 64, which is used in heating of the vehicle interior in the radiator 4. Consequently, the vehicle interior is heated without using the outdoor heat exchanger 7.

(9) Control of Compressor 2 in Heating Operation by Controller 32

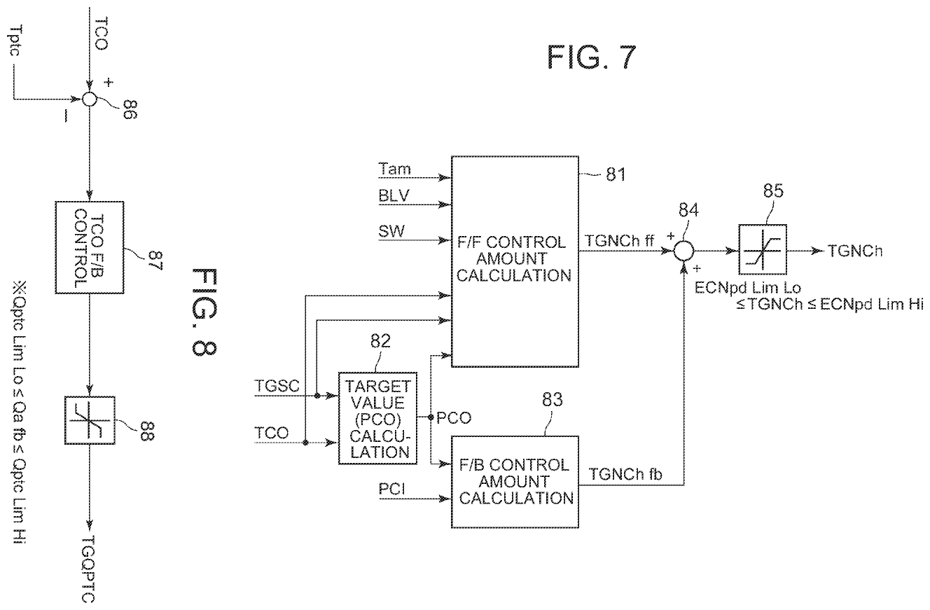

Next, the control of the compressor 2 in the aforementioned heating operation will be described in detail using FIG. 7. FIG. 7 is a control block diagram of the controller 32 which determines a target number of revolutions (a compressor target number of revolutions) TGNCh of the compressor 2 for the heating operation. An F/F (Feed Forward) control amount calculation section 81 of the controller 32 calculates an F/F control amount TGNChff of the compressor target number of revolutions on the basis of the outdoor air temperature Tarn obtained from the outdoor air temperature sensor 33, a blower voltage MN of the indoor blower 27, an air volume ratio SW by the air mix damper 28, a target supercool degree TGSC being a target value of a supercool degree SC at the outlet of the radiator 4, the target heater temperature TCO, and the target radiator pressure PCO being a target value of the pressure of the radiator 4.

The target radiator pressure PCO is calculated by a target value calculation section 82 based on the target supercool degree TGSC and the target heater temperature TCO described above. Further, an F/B (FeedBack) control amount calculation section 83 calculates n F/B control amount TGNChfb of the compressor target number of revolutions, based on the target radiator pressure PCO and the radiator pressure PCI being the refrigerant pressure of the radiator 4. Then, the F/F control amount TGNChff calculated by the F/F control amount calculation section 81 and TGNChfb calculated by the F/B control amount calculation section 83 are added by an adder 84 and attached with limits of an upper limit value ECNpdLimHi of controlling and a lower limit value ECNpdLimLo of controlling in a limit setting section 85, and then determined as the compressor target number of revolutions TGNCh. In the heating operation, the controller 32 controls the number of revolutions NC of the compressor 2 based on the compressor target number of revolutions TGNCh.

(10) Control of Auxiliary Heater 23 by Controller 32

Further, FIG. 8 is a control block diagram of the controller 32 which determines an auxiliary heater required capability TGQPTC of the auxiliary heater 23 in the auxiliary heater single operation. The target heater temperature TCO and the auxiliary heater temperature Tptc are input to a subtracter 86 of the controller 32 to calculate a deviation (TCO−Tptc) between the target heater temperature TCO and the auxiliary heater temperature Tptc. The deviation (TCO−Tptc) is input to an F/B control section 87, and the F/B control section 87 eliminates the deviation (TCO−Tptc) and calculates an auxiliary heater required capability F/B control amount so that the auxiliary heater temperature Tptc becomes the target heater temperature TCO.

The auxiliary heater required capability F/B control amount Qafb calculated in the F/B control section 87 is added with limits of a control upper limit value QptcLimHi and a control lower limit value QptcLimLo in a limit setting section 88 and then determined as the auxiliary heater required capability TGQPTC. In the auxiliary heater single operation, the controller 32 controls the energization of the auxiliary heater 23 based on the auxiliary heater required capability TGQPTC to thereby control the heat generation (heating) of the auxiliary heater 23 so that the auxiliary heater temperature Tptc becomes the target heater temperature TCO.

(11) Air Preconditioning by Controller 32

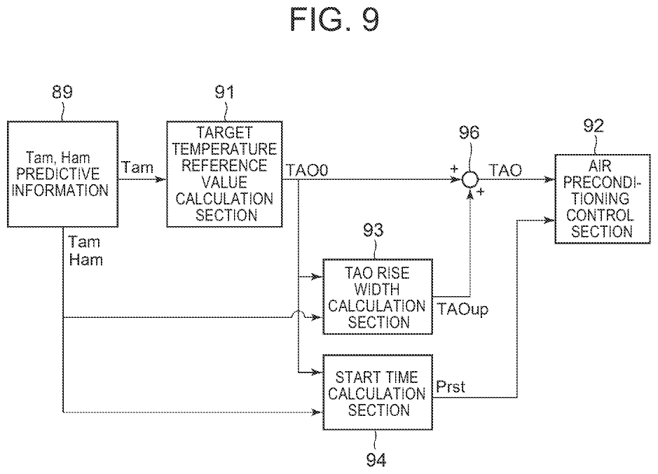

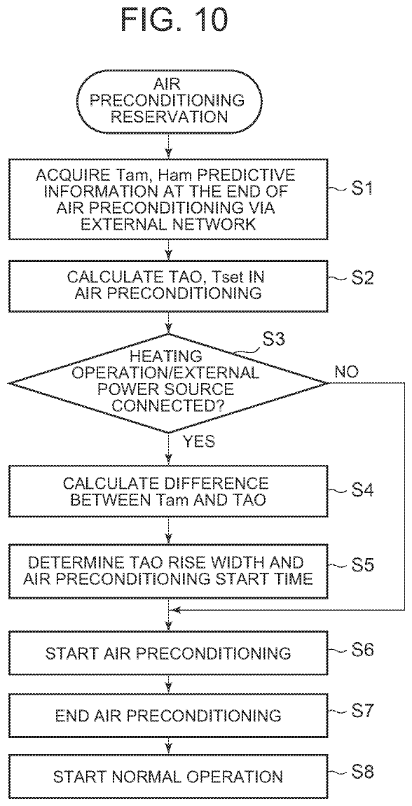

Next, description will be made as to air preconditioning of the vehicle interior by the controller 32 with reference to FIGS. 9 and 10. The controller 32 has an air preconditioning function of preliminarily air conditioning the vehicle interior before the vehicle is boarded. A reservation for the air preconditioning can be performed by the operation of the remote controller 53B provided in, for example, the vehicle key, and in the embodiment, a boarding time is assumed to be reserved and set. Accordingly, the set boarding time becomes an end time of the air preconditioning.

FIG. 9 is a control block diagram relating to the air preconditioning of the controller 32. A predictive information acquiring section 89 of FIG. 9 acquires from the vehicle side controller 80, predictive information related to an outdoor air temperature Tam and an outdoor air humidity Ham at the end of the air preconditioning which are acquired via the external network by the vehicle side controller 80.

The outdoor air temperature Tam at the end of the air preconditioning acquired by the predictive information acquiring section 89 is input to a target temperature reference value calculation section 91. The target temperature reference value calculation section 91 calculates reference values for the target outlet temperature TAO and the target vehicle interior air temperature Tset used in the air preconditioning, based on the outdoor air temperature Tam (predictive information) at the end of the air preconditioning which is input from the predictive information acquiring section 89.

A method of calculating the reference value of the target outlet temperature TAO used in the air preconditioning is basically similar to the aforementioned equation (I), but in the case of the air preconditioning, the predictive information at the end of the air preconditioning is used as the outdoor air temperature Tam. Further, in the present invention, the target temperature for control in the air preconditioning is either the target outlet temperature TAO or the target vehicle interior air temperature Tset, but as is apparent from the equation (I), when the target vehicle interior air temperature Tset rises, the target outlet temperature TAO also rises, whereas when the target vehicle interior air temperature Tset is lowered, the target outlet temperature TAO is also lowered. Therefore, in the following description, the target outlet temperature TAO will be described as the target temperature for control (including heating control) in the air preconditioning.

The outdoor air temperature Tam and the outdoor air humidity Ham at the end of the air preconditioning, which are acquired by the predictive information acquiring section 89 are further input to a TAO rise width calculation section 93 and a start time calculation section 94. The TAO rise width calculation section 93 calculates a rise width TAOup of the target outlet temperature TAO (target temperature) in the air preconditioning, based on the outdoor air temperature Tam and the outdoor air humidity Ham at the end of the air preconditioning. The start time calculation section 94 calculates an air preconditioning start time Prst, based on the outdoor air temperature Tam and the outdoor air humidity Ham at the end of the air preconditioning.

Incidentally, the air preconditioning start time Prst is set in advance to the start time calculation section 94 so as to range from a reserved boarding time (air preconditioning end time) to a time (default air preconditioning start time) before a predetermined time (a few minutes to several tens of minutes ago). However, in the heating operation, the start time calculation section 94 changes the air preconditioning start time Prst as will be described later.

The rise width TAOup output from the TAO rise width calculation section 93 and the reference value TAO0 of the target outlet temperature TAO calculated in the target temperature reference value calculation section 91 are added in an adder 96 and then input to an air preconditioning control section 92 as the target outlet temperature TAO. Further, the air preconditioning start time Prst output from the start time calculation section 94 is also input to the air preconditioning control section 92. The air preconditioning control section 92 starts air preconditioning at the input air preconditioning start time Prst and controls the operation of the air preconditioning on the basis of the target outlet temperature TAO (TAO0+TAOup).

Next, the air preconditioning by the controller 32 will be specifically described with reference to a flowchart of FIG. 10. When the air preconditioning is reserved in the controller 32, the predictive information acquiring section 89 acquires an outdoor air temperature Tam and an outdoor air humidity Ham at the end of the air preconditioning in Step S1 of FIG. 10. Next, in Step S2, the target temperature reference value calculation section 91 calculates reference values (in the embodiment, the reference value TAO0 of the target outlet temperature TAO) of a target outlet temperature TAO and a target vehicle interior air temperature Tset in the air preconditioning from the outdoor air temperature Tam at the end of the air preconditioning.

Next, the controller 32 determines whether or not the air conditioning operation executed in Step S3 is the heating operation and determines whether or not the battery 55 of the vehicle is connected to the external power source (quick charger or the like). In this case, the controller 32 selects the air conditioning operation at the start of air preconditioning from any of the air conditioning operations described above on the basis of the outdoor air temperature Tam (predictive information) and the reference value TAO0 of the target outlet temperature TAO at the end of the air preconditioning. Then, when the heating operation is not taken, and the battery 55 is not connected to the external power source even in the heating operation, the controller 32 proceeds to Step S6, where the air preconditioning control section 92 starts air preconditioning.

When the air conditioning operation selected in Step S3 is not the heating operation, and the external power source is not connected to the battery 55 even in the heating operation, the TAO rise width calculation section 93 sets TAOup to 0 (zero), and hence the air preconditioning control section 92 is inputted with the reference value TAO0 of the target outlet temperature TAO output from the target temperature reference value calculation section 91 as the target outlet temperature TAO. Further, since the start time calculation section 94 also outputs the default air preconditioning start time Prst when the heating operation is not taken, the air preconditioning control section 92 starts the air conditioning operation selected before the predetermined time from the reserved boarding time (air preconditioning end time) and controls the operation of the compressor 2 or the like at the target outlet temperature TAO. Then, when the air preconditioning end time (boarding time) comes, the controller 32 ends the air preconditioning in Step S7, and starts the normal air conditioning operation in Step S8.

On the other hand, when the air conditioning operation selected in Step S3 is the heating operation, and the external power source is connected to the battery 55, the controller 32 proceeds to Step S4. In Step S4, the TAO rise width calculation section 93 and the start time calculation section 94 respectively calculate a difference between the outdoor air temperature Tam (predictive information) and the reference value TAO0 of the target outlet temperature TAO. Then, in Step S5, the TAO rise width calculation section 93 determines a TAO rise width TAOup, and the start time calculation section 94 determines an air preconditioning start time Prst.

(11-1) Determination of TAO Rise Width TAOup by TAO Rise Width Calculation Section 93

In the case of the embodiment, when the difference between the outdoor air temperature Tam (predictive information) and the reference value TAO0 of the target outlet temperature TAO is a predetermined value or less, the TAO rise width calculation section 93 sets the TAO rise width TAOup as a default value TAOupd (a few degs). Thus, since the target outlet temperature TAO input to the air preconditioning control section 92 is changed in the direction of increasing it by TAOupd from the reference value TAO0, the target heater temperature TCO rises correspondingly, and the above-described compressor target number of revolutions TGNCh and auxiliary heater required capability TGQPTC rise, thereby increasing the heating capability in the vehicle interior.

(11-2) Change of TAO Rise Width TAOup by TAO Rise Width Calculation Section 93 (Part 1)

Further, in the embodiment, when the difference between the outdoor air temperature Tam (predictive information) and the reference value TAO0 of the target outlet temperature TAO is larger than the above predetermined value, the TAO rise width calculation section 93 changes the TAO rise width TAOup in the direction of increasing it as the difference from the predetermined value becomes larger. This change method may be one in which the rise width is changed linearly according to the difference or may be one in which the rise width is changed stepwise in units of 1 to a few degs. That is, as the outdoor air temperature Tam (predictive information) becomes low and the difference from the reference value TAO0 of the target outlet temperature TAO becomes larger, the TAO rise width TAOup is made large, and the compressor target number of revolutions TGNCh and the auxiliary heater required capability TGQPTC is more raised, thereby further increasing the heating capability of the vehicle interior.

(11-3) Determination of Air Preconditioning Start Time Prst by Start Time Calculation Section 94

Further, when the difference between the outdoor air temperature Tam (predictive information) and the reference value TAO0 of the target outlet temperature TAO is a predetermined value or less, the start time calculation section 94 sets the air preconditioning start time Prst to the above-described default air preconditioning start time.

(11-4) Change of Air Preconditioning Start Time Prst by Start Time Calculation Section 94 (Part 1)

On the other hand, in the embodiment, when the difference between the outdoor air temperature Tam (predictive information) and the reference value TAO0 of the target outlet temperature TAO is larger than the predetermined value, the start time calculation section 94 changes the air preconditioning start time Prst in the direction of advancing it as the difference from the predetermined value becomes larger. This change method may be one in which the air preconditioning start time is changed linearly according to the difference or may be one in which it is changed stepwise in units of 1 to several tens of minutes. That is, as the outdoor air temperature Tam (predictive information) becomes low and the difference from the reference value TAO0 of the target outlet temperature TAO becomes larger, the air preconditioning is started early, and the heating of the vehicle interior is performed longer.

(11-5) Heating of Vehicle Interior in Air Preconditioning

Then, the controller proceeds to Step S6, and the air preconditioning control section 92 starts air preconditioning, but in the air preconditioning heating in a state where the external power source is connected to the battery 55, the controller 32 executes the auxiliary heater single operation of (5) described above or the waste heat recovery heating mode of the heating operation of (8) described above. That is, the vehicle interior is heated without letting the refrigerant flow through the outdoor heat exchanger 7. In this case, which operation is performed may be set in advance. For example, when the temperature of the battery 55 is equal to or higher than the predetermined value, the waste heat recovery heating mode of (8) may be performed, and when the temperature is lower than the predetermined value, the auxiliary heater single operation of (5) may be performed. Consequently, the interior of the vehicle can be heated while controlling the temperature of the battery 55 without hindrance (preventing overcooling). Incidentally, Steps S7 and subsequent Steps are the same as described above.

As described above, in the present invention, the controller 32 is capable of executing air preconditioning for preliminarily heating the vehicle interior before boarding. When the air preconditioning is performed in the state in which the battery 55 is connected to the external power source, the interior of the vehicle is heated without using the outdoor heat exchanger 7. Therefore, the interior of the vehicle can be preliminarily heated without frosting on the outdoor heat exchanger 7 in the air preconditioning before boarding.

In the present invention, in addition to this, the controller 32 changes the target temperature for heating control in air preconditioning, and the target outlet temperature TAO in the embodiment in the direction of increasing from the reference value TAO0. Therefore, it is possible to increase the heating capability and store heat in the air in the vehicle interior and parts inside the vehicle such as seats during the air preconditioning. That is, it is possible to reduce the load when executing the heating operation (normal heating mode) in which the outdoor heat exchanger 7 absorbs heat from the outdoor air during running or the like after disconnecting the battery 55 and the external power source. Consequently, it is possible to reduce frost formation on the outdoor heat exchanger 7 and extend a period during which the heating operation can be performed with high efficiency, particularly under a low outdoor air temperature environment.

In particular, in the embodiment, the start time calculation unit 94 of the controller 32 changes the time Prst at which the air preconditioning is started in the direction of advancing it as the difference between the outdoor air temperature Tam and the reference value TAO0 increases. Therefore, it is possible to store heat in the vehicle interior without any trouble in the air preconditioning even in an environment where the outdoor air temperature Tarn is low.

Further, in the embodiment, the TAO rise width calculation section 93 of the controller 32 changes the rise width TAOup (target temperature rise width) of the target outlet temperature TAO in the direction of increasing it as the difference between the outdoor air temperature Tam and the reference value TAO0 increases. It is therefore possible to store heat in the vehicle interior without any trouble by air preconditioning under an environment where the outdoor air temperature Tam is low.

In this case, since the outdoor air temperature Tam (predictive information) at the end of air preconditioning is adopted as the outdoor air temperature Tam in the embodiment, it is possible to realize air preconditioning according to the outdoor air temperature Tarn at the time of boarding.

Further, in the embodiment, the target temperature reference value calculation section 91 of the controller 32 calculates the reference value TAO0 of the target outlet temperature TAO, based on the outdoor air temperature Tam at the end of the air preconditioning. It is therefore possible to realize appropriate air preconditioning according to the outdoor air temperature Tarn at the time of boarding.

In that case, in the embodiment, since the controller 32 acquires the information about the outdoor air temperature Tam at the end of the air preconditioning via the external network, the air preconditioning corresponding to the outdoor air temperature Tarn at the time of boarding can be realized without hindrance.

(11-6) Change of TAO Rise Width TAOup by TAO Rise Width Calculation Section 93 (Part 2)

Incidentally, the change (Part 1) of the TAO rise width TAOup by the TAO rise width calculation section 93 of (11-2) described above may be performed based on the outdoor air humidity Ham instead of or in addition to the difference between the outdoor air temperature Tarn and the reference value TAO0 described above. In that case, when the outdoor air humidity Ham (predictive information) is equal to or less than a predetermined value, the TAO rise width calculation section 93 sets the TAO rise width TAOup to the above-mentioned default value TAOupd (several degs).

On the other hand, as the outdoor air humidity Ham becomes higher than the predetermined value and the difference from the predetermined value becomes larger, the TAO rise width TAOup is changed in the direction of increasing it. This change method may be one in which the TAO rise width is changed linearly according to the difference or may be one in which the TAO rise width is changed stepwise in units of 1 to several dogs. That is, in this case, as the outdoor air humidity Ham (predictive information) becomes higher, the TAO rise width TAOup is made large, and the compressor target number of revolutions TGNCh and the auxiliary heater required capability TGQPTC are further increased to thereby further increase the heating capability in the vehicle interior.

When (11-6) is executed instead of (11-2), the TAO rise width TAOup is set to the default value TAOupd (several degs) where the outdoor air humidity Ham (predictive information) is the predetermined value or less, without considering the difference between the outdoor air temperature Tarn (predictive information) and the reference value TAO0 of the target outlet temperature TAO upon determining the TAO rise width TAOup by the TAO rise width calculation section 93 of (11-1) described above.

(11-7) Change of Air Preconditioning Start Time Prst by Start Time Calculation Section 94 (Part 2)

Further, even regarding the change (Part 1) of the air preconditioning, start time Prst by the start time calculation section 94 of (11-4) described above, its change may be performed based on the outdoor air humidity Ham instead of or in addition to the difference between the outdoor air temperature Tam and the reference value TAO0 described above. In that case, when the outdoor air humidity Ham (predictive information) is equal to or less than a predetermined value, the start time calculation section 94 sets the air preconditioning start time Prst to the default air preconditioning start time described above.

On the other hand, the start time calculation on section 94 changes the air preconditioning start time Prst in the direction of advancing it as the outdoor air humidity Ham (predictive information) becomes higher than the predetermined value and the difference from the predetermined value becomes larger. This change method may be one in which the air preconditioning start time is changed linearly according to the difference, or may be one in which it is changed stepwise in units of 1 to several minutes. That is, in this case, the higher the outdoor air humidity Ham (predictive information), the earlier the air preconditioning is started, and the longer the heating of the vehicle interior is performed.

When (11-7) is executed instead of (11-4), the air preconditioning start time Prst is set to the default air preconditioning start time where the outdoor air humidity Ham (predictive information) is the predetermined value or less, without considering the difference between the outdoor air temperature Tam (predictive information) and the reference value TAO0 of the target outlet temperature TAO upon determining the air preconditioning start time Prst by the start time calculation section 94 of (11-3) described above.

Thus, if the controller 32 changes the time Prst at which the air preconditioning is started in the direction of advancing it as the outdoor air humidity Ham increases, it is possible to store heat in the vehicle interior without hindrance by air preconditioning and effectively reduce frost formation on the outdoor heat exchanger 7 during subsequent running, under an environment in which the outdoor air humidity Ham is high and the outdoor heat exchanger 7 is likely to be frosted.

Further, even if the controller 32 changes the rise width TAOup of the target outlet temperature TAO in the direction of increasing the rise width TAOup thereof as the outdoor air humidity Ham becomes higher, it is possible to store heat in the vehicle interior without hindrance by the air preconditioning and effectively reduce frost formation on the outdoor heat exchanger 7 during the subsequent traveling, under an environment where frost is likely to be formed on the outdoor heat exchanger 7.

In this case as well, since the outdoor air humidity Ham (predictive information) at the end of air preconditioning is used as the outdoor air humidity Ham, it becomes possible to realize air preconditioning according to the outdoor air humidity Ham when boarding.

Further, since the controller 32 acquires the information regarding the outdoor air humidity Ham at the end of the air preconditioning via the external network, it is possible to realize the air preconditioning according to the outdoor air humidity Ham at the time of boarding without hindrance.

Incidentally, in the embodiment, the reference value TAO0 (the reference value of the target temperature for heating control) of the target outlet temperature TAO in the air preconditioning, is calculated from the outdoor air temperature Tarn (predictive information) at the end of the air preconditioning, but not limited to it. It may be calculated from the outdoor air humidity Ham (predictive information) at the end of air preconditioning, or may be calculated in consideration of the outdoor air humidity Ham.

Also, instead of calculating the reference value, the reference value set in advance or the target outlet temperature TAO calculated from the target vehicle interior air temperature Tset set immediately before by the user may be treated as the reference value TAO0.

Further, in the embodiment, the boarding time (air preconditioning end time) is set for the reservation of air preconditioning, but the inventions other than claims 4 and 8 are not limited thereto, and the start time of air preconditioning may be reserved. In that case, since the end time of air preconditioning becomes unknown, the predictive information of the outdoor air temperature and outdoor air humidity at the air preconditioning start reservation time, or the outdoor air temperature and outdoor air humidity after a predetermined time (several minutes to several tens of minutes) is acquired, and each control described above may be executed. Further, regarding the change of the air preconditioning start time in that case, the controller 32 voluntarily changes the start reservation time.

In addition, the heating in the air preconditioning is also described in the auxiliary heater single operation or the waste heat recovery heating mode in the embodiment, but the inventions other than claims 10 and 11 are not limited thereto, and various changes are possible if a heating system which does not use the outdoor heat exchanger 7 is adopted.

Furthermore, in the embodiment, description has been made as to the case where the battery 55 is cooled via the heat medium, but a heat exchanger for waste heat recovery that directly exchanges heat with the battery 55 may be provided so that heat is directly absorbed from the battery 55 by the refrigerant.

In addition, in the embodiment, in addition to the heating operation, the vehicular air-conditioning device that executes the dehumidifying and heating operation, the dehumidifying and cooling operation, the cooling operation, the defrosting operation, etc. has been taken up and described, but the present invention is not limited thereto. The present invention is also effective for a vehicular air-conditioning device that executes only the heating operation, or either of the above-mentioned air conditioning operation and defrosting operation in addition to the heating operation, or a combination thereof.

Moreover, the configuration of the controller 32 described in the embodiment, and the configurations of the refrigerant circuit R and the waste heat recovering device 61 of the vehicular air-conditioning device 1 are not limited thereto, and needless to say can be changed within the scope not departing from the spirit of the present invention.

### DESCRIPTION OF REFERENCE NUMERALS

1 vehicular air-conditioning device
2 compressor
4 radiator
6 outdoor expansion valve
7 outdoor heat exchanger
8 indoor expansion valve
9 heat absorber
13 refrigerant pipe
32 controller (control device)
53B remote controller
55 battery (heat generating device)
61 waste heat recovering device
62 circulating pump
64 refrigerant-heat medium heat exchanger (waste heat recovering heat exchanger)
68 heat medium pipe
72 branch pipe
73 auxiliary expansion valve
74 refrigerant pipe
89 predictive information acquiring section
91 target temperature reference value calculation section
92 air preconditioning control section
93 TAO rise width calculation section
94 start time calculation section
R refrigerant circuit.

1. A vehicular air-conditioning device comprising:
a compressor supplied with power from a battery to compress a refrigerant;
a radiator to let the refrigerant radiate heat, thereby heating air to be supplied to a vehicle interior;
an outdoor heat exchanger provided outside the vehicle interior; and
a control device,
wherein the battery is capable of being charged by an external power source,
wherein the control device at least executes a heating operation to heat the vehicle interior by letting the refrigerant discharged from the compressor radiate heat in the radiator, decompressing the refrigerant from which the heat is radiated, and then letting the refrigerant absorb heat in the outdoor heat exchanger,
wherein the control device is capable of executing air preconditioning to preliminarily heat the vehicle interior before boarding, and
wherein when the air preconditioning is executed in a state in which the battery is connected to the external power source, the control device heats the vehicle interior without using the outdoor heat exchanger, and changes a target temperature for heating control in the air preconditioning in the direction of increasing from a reference value of the target temperature.

2. The vehicular air-conditioning device according to claim 1, wherein the control device changes the time to start the air preconditioning in the direction of advancing the time as a difference between an outdoor air temperature and the reference value of the target temperature becomes larger.

3. The vehicular air-conditioning device according to claim 1, wherein the control device changes a rise width of the target temperature in the direction of increasing the rise width as the difference between the outdoor air temperature and the reference value of the target temperature increases.

4. The vehicular air-conditioning device according to claim 2, wherein the outdoor air temperature is an outdoor air temperature at the end of the air preconditioning.

5. The vehicular air-conditioning device according to claim 1, wherein the control device changes the time to start the air preconditioning in the direction of advancing the time as an outdoor air humidity becomes higher.

6. The vehicular air-conditioning device according to claim 1, wherein the control device changes the rise width of the target temperature in the direction of increasing the rise width as the outdoor air humidity increases.

7. The vehicular air-conditioning device according to claim 5, wherein the outdoor air humidity is an outdoor air humidity at the end of the air preconditioning.

8. The vehicular air-conditioning device according to claim 1, wherein the control device calculates the reference value of the target temperature, based on the outdoor air temperature and/or outdoor air humidity at the end of the air preconditioning.

9. The vehicular air-conditioning device according to claim 4, wherein the control device acquires information relating to the outdoor air temperature and/or outdoor air humidity at the end of the air preconditioning via an external network.

10. The vehicular air-conditioning device according to claim 1, including:
an electric heater to heat the air supplied to the vehicle interior,
wherein when the air preconditioning is executed in a state in which the battery is connected to the external power source, the control device stops the compressor and heats the vehicle interior by the electric heater.

11. The vehicular air-conditioning device according to claim 1, including:
a waste heat recovering heat exchanger to recover waste heat from a heat generating device mounted on a vehicle by using the refrigerant,
wherein when the air preconditioning is executed in a state in which the battery is connected to the external power source, the control device operates the compressor, lets the refrigerant discharged from the compressor radiate heat, decompresses the refrigerant from which the heat is radiated, and then lets the refrigerant absorb heat in the waste heat recovering heat exchanger.

12. The vehicular air-conditioning device according to claim 2, wherein the control device changes a rise width of the target temperature in the direction of increasing the rise width as the difference between the outdoor air temperature and the reference value of the target temperature increases.

13. The vehicular air-conditioning device according to claim 3, wherein the outdoor air temperature is an outdoor air temperature at the end of the air preconditioning.

14. The vehicular air-conditioning device according to claim 4, wherein the control device changes the time to start the air preconditioning in the direction of advancing the time as an outdoor air humidity becomes higher.

15. The vehicular air-conditioning device according to claim 5, wherein the control device changes the rise width of the target temperature in the direction of increasing the rise width as the outdoor air humidity increases.

16. The vehicular air-conditioning device according to claim 6, wherein the outdoor air humidity is an outdoor air humidity at the end of the air preconditioning.

17. The vehicular air-conditioning device according to claim 7, wherein the control device calculates the reference value of the target temperature, based on the outdoor air temperature and/or outdoor air humidity at the end of the air preconditioning.

18. The vehicular air-conditioning device according to claim 8, wherein the control device acquires information relating to the outdoor air temperature and/or outdoor air humidity at the end of the air preconditioning via an external network.

19. The vehicular air-conditioning device according to claim 9, including:
an electric heater to heat the air supplied to the vehicle interior,
wherein when the air preconditioning is executed in a state in which the battery is connected to the external power source, the control device stops the compressor and heats the vehicle interior by the electric heater.

20. The vehicular air-conditioning device according to claim 9, including:
a waste heat recovering heat exchanger to recover waste heat from a heat generating device mounted on a vehicle by using the refrigerant,
wherein when the air preconditioning is executed in a state in which the battery is connected to the external power source, the control device operates the compressor, lets the refrigerant discharged from the compressor radiate heat, decompresses the refrigerant from which the heat is radiated, and then lets the refrigerant absorb heat in the waste heat recovering heat exchanger.
